(19) United States
(12) Patent Application Publication
(10) Pub. No.: US 2022/0187566 A1
(43) Pub. Date: Jun. 16, 2022

(54) LENS PRISM MODULE

(71) Applicant: Changzhou AAC Raytech Optronics Co., Ltd., Changzhou City (CN)

(72) Inventors: Tongming Xu, Shenzhen (CN); Gang Li, Shenzhen (CN)

(21) Appl. No.: 17/530,490

(22) Filed: Nov. 19, 2021

(30) Foreign Application Priority Data
Nov. 24, 2020 (CN) 202022754050.2

(51) Int. Cl. G02B 7/18; G02B 27/64; H01F 7/08

(52) U.S. Cl. CPC G02B 7/1805; H01F 7/081; G02B 27/646

(57) ABSTRACT

A lens prism module relates to the field of shooting equipment and includes a fixed base, a rotating base, a prism, and a driving assembly. The rotating base includes rotating shafts connected with the fixed base. The rotating base is recessed to form rotating grooves. A bottom portion of each rotating groove includes supporting surface structures disposed obliquely with respect to an axis of the rotating shafts. One end of each rotating shaft is of a curved surface structure. Each curved surface structure is tangent to a corresponding supporting surface structure for realizing rotation of the rotating base, which reduce resistance of rotation, reduces a driving force for driving rotation of the rotating base, so that the lens prism module responds quickly when performing an optical image stabilization function. Meanwhile, it limits shaking of the rotating shafts and the rotating shafts are stably rotatably connected with the rotating base.

### TECHNICAL FIELD

The present disclosure relates to the field of shooting equipment, and in particular to a lens prism module.

### BACKGROUND

With improvement of living standards, development of imaging technology and wide applications of products with imaging functions and optical lenses are applied to various electronic products, such as digital cameras, digital video cameras, and smart shooting equipment.

A lens prism module in the related art comprises a fixed base, a rotating base, a mounting base disposed on the rotating base, a prism disposed on the mounting base, a rotating connecting structure for rotatably connecting the rotating base and the mounting base, and a driving assembly for driving. In the related art, the rotating connecting structure experiences severe shaking during a rotating process, and the lens prism module shakes severely when performing an optical image stabilization function. The lens prism module has a poor adjustment effect and poor stability.

### SUMMARY

The present disclosure provides a lens prism module to solve a problem that a conventional lens prism module shakes severely when performing an optical image stabilization function.

Embodiments of the present disclosure is realized by providing a lens prism module. The lens prism module comprises a fixed base, a rotating base rotatably connected with the fixed base, a prism disposed on the rotating base, and a driving assembly for driving the rotating base to rotate. The rotating base comprises rotating shafts rotatably connected with the fixed base. The rotating base is recessed to form rotating grooves. A bottom portion of each of the rotating grooves comprises a plurality of supporting surface structures. The plurality of supporting surface structures are disposed obliquely with respect to an axis of the rotating shafts. One end of each of the rotating shafts close to a corresponding rotating groove is of a curved surface structure. The curved surface structure of each of the rotating shafts is tangent to the plurality of supporting surface structures of the corresponding rotating groove for realizing rotation of the rotating base.

As an improvement, the plurality of supporting surface structures of each of the rotating grooves are rotationally symmetrical with respect to the axis of the rotating shafts.

As an improvement, the plurality of supporting surface structures of each of the rotating grooves comprise a first supporting surface structure, a second supporting surface structure, and a third supporting surface structure. Included angles between the first supporting surface structure, the second supporting surface structure, and the third supporting surface structure of each of the rotating grooves are equal.

As an improvement, the driving assembly comprises a first driving coil disposed on the fixed base and a first driving magnet disposed on the rotating base. The first driving coil is disposed opposite to the first driving magnet.

As an improvement, the lens prism module further comprises return magnet groups oppositely disposed on the fixed base and the rotating base. The return magnet groups comprise a first return magnet group disposed on the rotating base and a second return magnet group disposed on the fixed base.

As an improvement, the first return magnet group comprises four first return magnets oppositely disposed on two sides of the rotating base. Each two of the four first return magnets are separately disposed on two sides of a corresponding rotating groove. Each two of the four first return magnets disposed on the corresponding rotating groove distributed in a straight line with the corresponding rotating groove. The second return magnet group comprises four second return magnets oppositely disposed on two sides of the fixed base. Each of the second return magnets is disposed directly opposite to a corresponding first return magnet.

As an improvement, an avoiding groove for avoiding one end of the prism is provided on a bottom surface of the fixed base.

As an improvement, the lens prism module further comprises a Hall sensor disposed on the fixed base and a Hall magnet disposed on the rotating base. The Hall magnet is disposed opposite to the Hall sensor.

As an improvement, the lens prism module further comprises a circuit board disposed under the fixed base. The circuit board is connected with the fixed base through a reinforcing plate.

In the embodiments of the present disclosure, by forming the rotating grooves recessed in the rotating base, by providing the plurality of supporting surface structures on the bottom portion of each of the rotating grooves, and by setting the one end of each of the rotating shafts close to the corresponding rotating groove as the curved surface structure, the curved surface structure of each of the rotating shafts is tangent to the plurality of supporting surface structures of the corresponding rotating groove for realizing rotation of the rotating base, which reduce resistance of rotation, thereby reducing a driving force for driving the rotation of the rotating base, so that the lens prism module responds quickly when performing the optical image stabilization function. Meanwhile, it limits shaking of the rotating shafts, so the rotating shafts stably rotatably connected with the rotating base.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor. In the drawing:

FIG. 1 is an exploded schematic diagram of a lens prism module according to one embodiment of the present disclosure.

FIG. 2 is a structural schematic diagram of a fixed base and a circuit board of the lens prism module according to one embodiment of the present disclosure.

FIG. 3 is a schematic diagram showing an overall structure of the lens prism module according to one embodiment of the present disclosure.

FIG. 4 is a structural schematic diagram of the fixed base and a rotating base of the lens prism module according to one embodiment of the present disclosure.

FIG. 5 is a cross-sectional schematic diagram taken along a line A-A shown in FIG. 3.

FIG. 6 is an enlarged schematic diagram of area C shown in FIG. 5.

FIG. 7 is a cross-sectional schematic diagram taken along a line B-B shown in FIG. 3.

FIG. 8 is a structural schematic diagram of the rotating base of the lens prism module according to one embodiment of the present disclosure.

FIG. 9 is a cross-sectional schematic diagram taken along a line D-D shown in FIG. 3.

In the drawings:
1—fixed base; 2—rotating base; 3—rotating shaft; 31—curved surface structure, 4—Hall magnet; 5—rotating groove; 51—supporting surface structure; 511—first supporting surface structure; 512—second supporting surface structure; 513—third supporting surface structure; 6—driving assembly; 61—first driving coil; 62—first driving magnet; 7—first receiving groove; 8—second receiving groove; 9—return magnet group; 91—first return magnet; 10—second return magnet group; 101—second return magnet; 11—Hall sensor; 12—circuit board; 13—reinforcing board; 14—prism; 15—fixed groove; 16—mounting block; 161—mounting groove; 17—avoiding groove.

### DETAILED DESCRIPTION OF EMBODIMENTS

In order to make purposes, technical solutions, and advantages of the present disclosure clear, the following further describes the present disclosure with reference to the accompanying drawings and embodiments. It should be understood that the specific embodiments described herein are only used to explain the present disclosure and are not intend to limit the present disclosure.

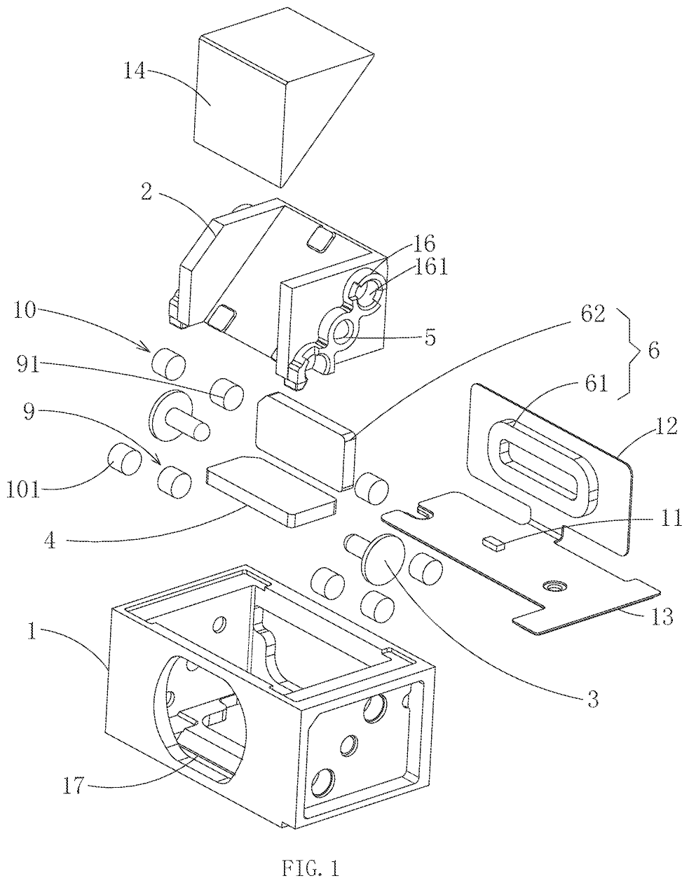

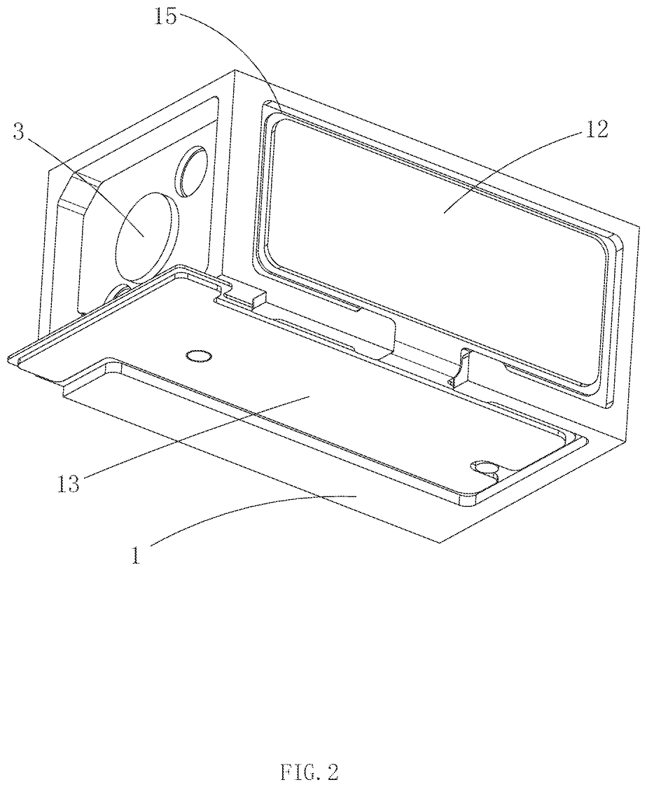

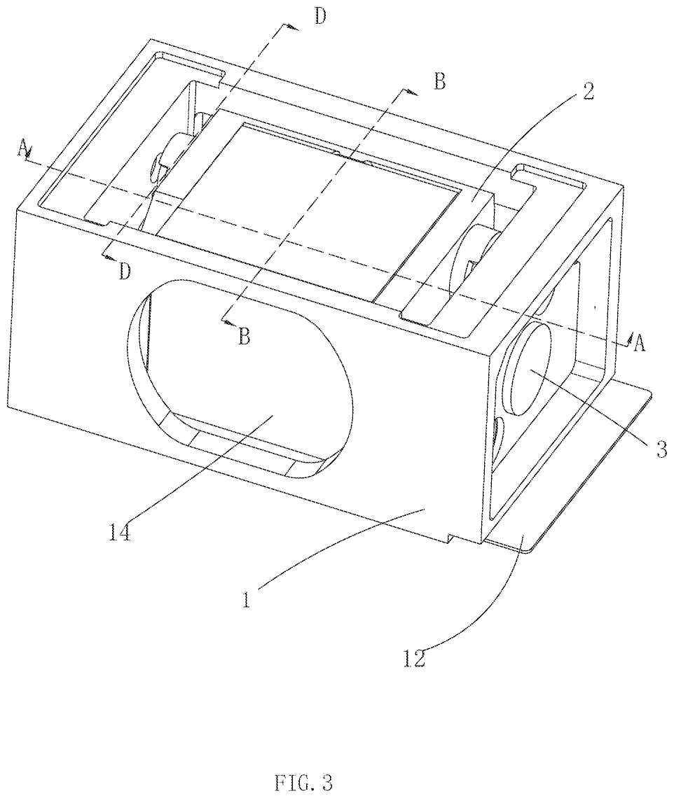

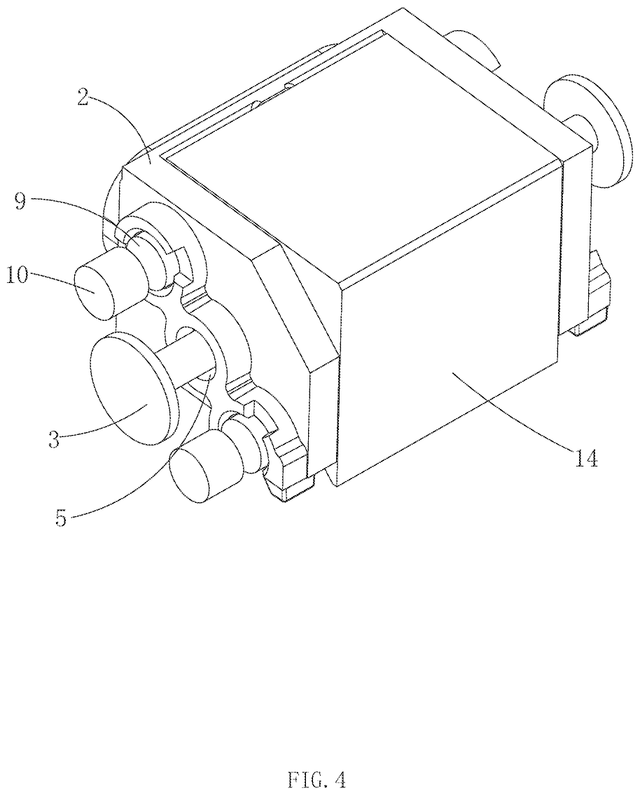

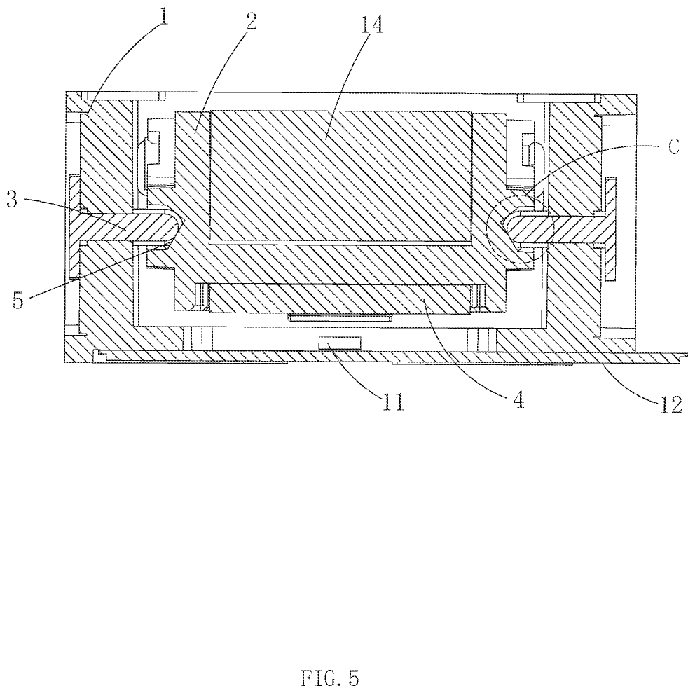

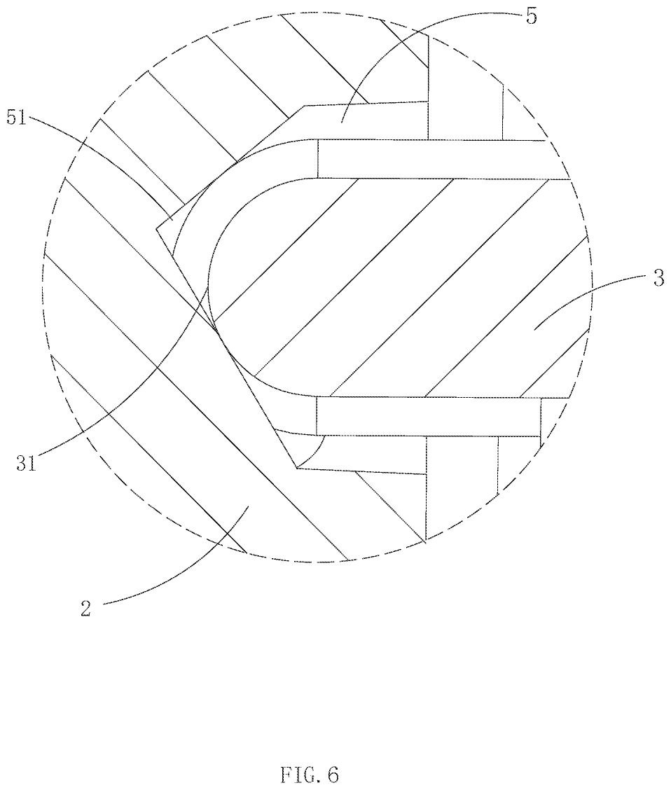

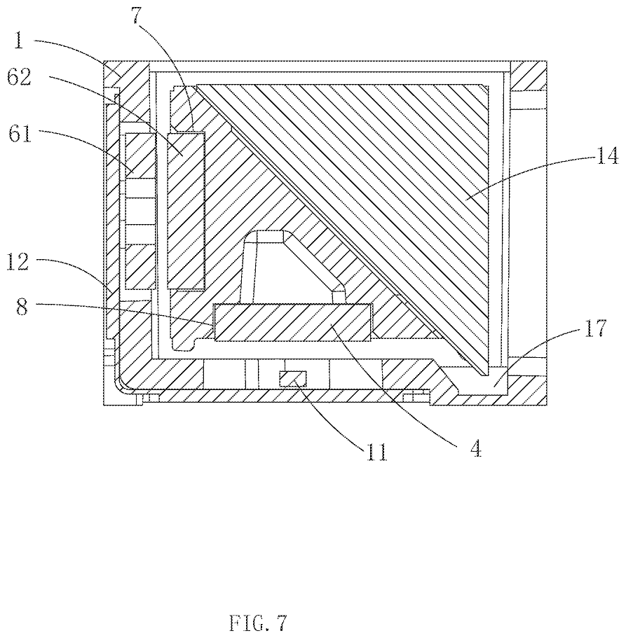

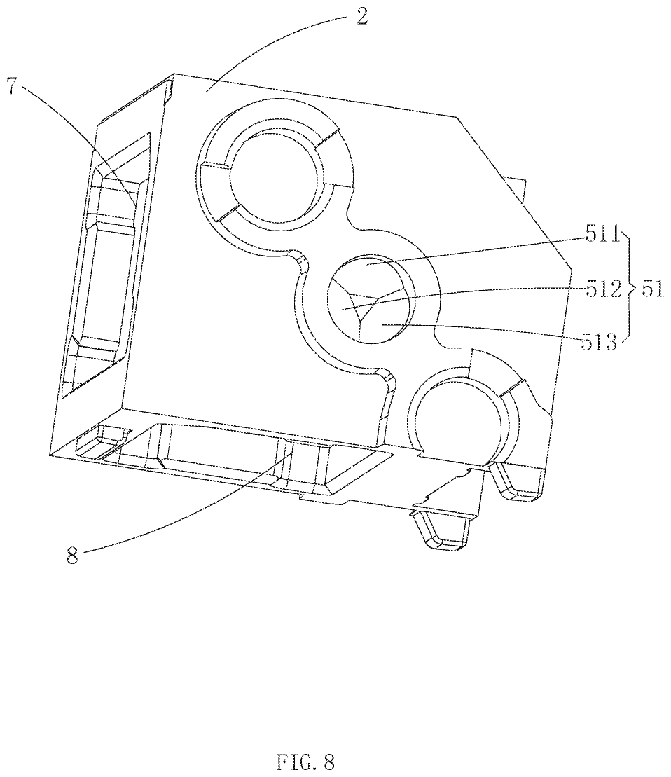

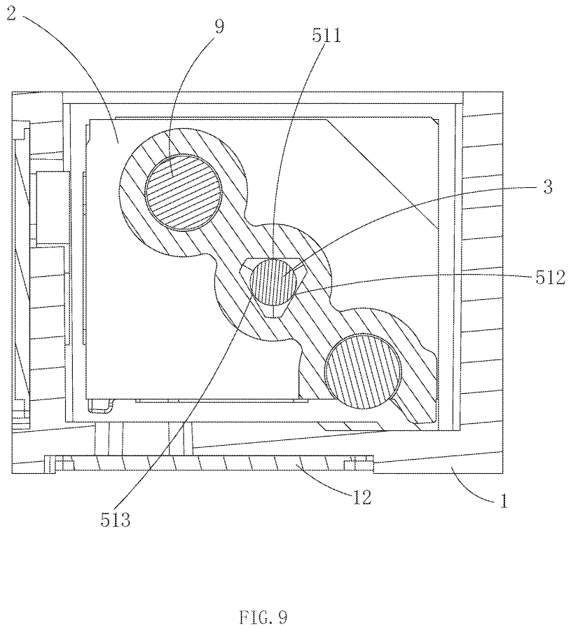

As shown in FIGS. 1-9, embodiments of the present disclosure provide a lens prism module. The lens prism module comprises a fixed base 1, a rotating base 2 rotatably connected with the fixed base 1, a prism 14 disposed on the rotating base 2, and a driving assembly 6 for driving the rotating base 2 to rotate. The rotating base 2 comprises rotating shafts 3 rotatably connected with the fixed base 1. The rotating base is recessed to form rotating grooves 5. A bottom portion of each of the rotating grooves 5 comprises a plurality of supporting surface structures 51. The plurality of supporting surface structures 51 are disposed obliquely with respect to an axis of the rotating shafts 3. One end of each of the rotating shafts 3 close to a corresponding rotating groove 5 is of a curved surface structure 31. The curved surface structure 31 of each of the rotating shafts 3 is tangent to the plurality of supporting surface structures 51 of the corresponding rotating groove for realizing rotation of the rotating base 2. By forming the rotating grooves 5 recessed in the rotating base 2, by providing the plurality of supporting surface structures 51 on the bottom portion of each of the rotating grooves 5, and by setting the one end of each of the rotating shafts 3 close to the corresponding rotating groove as the curved surface structure 31, the curved surface structure 31 of each of the rotating shafts 3 is tangent to the plurality of supporting surface structures 51 of the corresponding rotating groove 5 for realizing rotation of the rotating base 2, which reduce resistance of rotation, thereby reducing a driving force for driving the rotation of the rotating base 2, so that the lens prism module responds quickly when performing the optical image stabilization function. Meanwhile, it limits shaking of the rotating shafts 3, so the rotating shafts 3 are stably rotatably connected with the rotating base 2.

Specifically, the plurality of supporting surface structures 51 of each of the rotating grooves 5 are rotationally symmetrical with respect to the axis of the rotating shafts 3. Thus, the rotating shafts are stably supported by the plurality of supporting surface structures 51.

Specifically, the plurality of supporting surface structures 51 of each of the rotating grooves 5 comprise a first supporting surface structure 511, a second supporting surface structure 512, and a third supporting surface structure 513. Included angles between the first supporting surface structure 511, the second supporting surface structure 512, and the third supporting surface structure 513 of each of the rotating grooves 5 are equal. Thus, a front end of each of the rotating shafts 3 evenly contacts corresponding three supporting surface structures 51, the force is evenly received, and the supporting effect is good.

Specifically, the driving assembly 6 comprises a first driving coil 61 disposed on the fixed base and a first driving magnet 62 disposed on the rotating base 2. The first driving coil 61 is disposed opposite to the first driving magnet. When the first driving coil 61 is energized, the first driving magnet 62 drives the rotating base 2 to rotate along the rotating shafts 3.

Specifically, one side of the rotating base 2 is recessed inward to form a first receiving groove 7 for receiving the first driving magnet 62. Thus, the first driving magnet 62 is hidden in the first receiving groove 7 for reducing a volume of an overall structure of the lens prism module, thereby realizing requirements of miniaturization design. Moreover, fixing effect of the first driving magnet 62 is improved, thereby increasing stability of the first driving magnet 62 during operation.

Specifically, the lens prism module further comprises return magnet groups oppositely disposed on the fixed base 1 and the rotating base 2. The return magnet groups comprise a first return magnet group 9 disposed on the rotating base 2 and a second return magnet group 10 disposed on the fixed base 1. The first return magnet group 9 is disposed in mounting grooves 161 on two sides of the rotating base 2, and the second return magnet group 10 is mounted and fixed on two sides of the fixed base 1, so that the first return magnet group 9 and the second return magnet group 10 are well fixed to prevent from falling off. Since the first return magnet group 9 is corresponding to the second return magnet group 10, when the first drive coil 61 is turned off, the first return magnet group 9 and the second return magnet group 10 cooperate with the rotating shafts 3 to rotate the rotating base to an initial position.

Specifically, the first return magnet group 9 comprises four first return magnets 91 oppositely disposed on two sides of the rotating base 2. Each two of the four first return magnets 91 are separately disposed on two sides of a corresponding rotating groove 5. Each two of the four first return magnets 91 disposed on the corresponding rotating groove 5 distributed in a straight line with the corresponding rotating groove 5. The second return magnet group 10 comprises four second return magnets 101 oppositely disposed on two sides of the fixed base 1. Each of the second return magnets 101 is disposed directly opposite to a corresponding first return magnet 91. By arranging each return magnet 91 to face the corresponding second return magnet 101, when the first drive coil 61 is turned off, the four first return magnets 91 and the four second return magnets 101 cooperate with the rotating shafts 3 to rotate the rotating base 2 to the initial position. Such arrangements maximize use of the restoring force of the first return magnets 91 and the second return magnets 101 while making the restoring force uniform.

As an improvement, mounting blocks 16 separately protruding and disposed on the two sides of the rotating base 2 are recessed inward to from the mounting grooves 161, so the mounting grooves 161 have a good fixing effect on the rotating base 2 and are convenient to mount and fix the first return magnet group 9.

Specifically, an avoiding groove 17 for avoiding one end of the prism 14 is provided on a bottom surface of the fixed base 1. Therefore, a position of the prism 14 is limited during mounting of the prism 14 to the rotating base 2 while a height of the fixed base 1 is reduced under a premise of ensuring the larger-sized prism, thereby reducing the volume of the overall structure of the lens prism module

Specifically, the lens prism module further comprises a Hall sensor 11 disposed on the fixed base 1 and a Hall magnet 4 disposed on the rotating base 2. The Hall magnet 4 is disposed opposite to the Hall sensor 11 The Hall sensor is 11 disposed on one side of the Hall magnet 4. Therefore, a rotation angle of the rotating base 2 is accurately obtained, and the rotation angle of the rotating base 2 is well adjusted.

As an improvement, a bottom portion of the rotating base 2 is recessed inward to form a second receiving groove 8 for receiving the magnet 4. Thus, the Hall magnet 4 is hidden in the second receiving groove 8, so as to reduce the volume of the overall structure of the lens prism module, thereby realizing the requirements of miniaturization design. Further, it improves fixing effect of the Hall magnet 4, thereby increasing stability of the Hall magnet 4 during operation.

Specifically, the lens prism module further comprises a circuit board 12 disposed under the fixed base 1. The circuit board 12 is connected with the fixed base 1 through a reinforcing plate 13. Therefore, the circuit board 12 is fixed, the circuit board 12 is prevented from being damaged during fixing, and the circuit board 12 is protected. Of course, according to actual needs, the reinforcing plate 13 is disposed on one side of the circuit board 12.

Specifically, the circuit board 12 is mounted in a fixed groove 15 of the fixed base 1, which well protect the circuit board 12 and avoids damage to the circuit board 12.

As an improvement, one side of the fixed base 1 is recessed inward to form the fixed groove 15. The fixed groove 15 is convenient for hiding the circuit board 12 in the fixed base 1 and has a good protection effect. Meanwhile, an installation space of the circuit board 12 is saved.

In the embodiments of the present disclosure, by forming the rotating grooves 5 recessed in the rotating base 2, by providing the plurality of supporting surface structures 51 on the bottom portion of each of the rotating grooves 5, and by setting the one end of each of the rotating shafts 3 close to the corresponding rotating groove 5 as the curved surface structure 31, the curved surface structure 31 of each of the rotating shafts 3 is tangent to the plurality of supporting surface structures 51 of the corresponding rotating groove 5 for realizing rotation of the rotating base 2, which reduce resistance of rotation, thereby reducing a driving force for driving the rotation of the rotating base 2, so that the lens prism module responds quickly when performing the optical image stabilization function. Meanwhile, it limits shaking of the rotating shafts 3, so the rotating shafts stably rotatably connected with the rotating base 2.

Foregoing descriptions are only optional embodiments of the present disclosure and are not intended to limit the present disclosure. Any modification, equivalent replacement, or improvement within spirit and principle of the present disclosure should be included in the protection scope of the present disclosure.

What is claimed is:

1. A lens prism module, comprising:
a fixed base;
a rotating base rotatably connected with the fixed base;
a prism disposed on the rotating base; and
a driving assembly for driving the rotating base to rotate;
wherein the rotating base comprises rotating shafts rotatably connected with the fixed base; the rotating base is recessed to form rotating grooves; a bottom portion of each of the rotating grooves comprises a plurality of supporting surface structures; the plurality of supporting surface structures are disposed obliquely with respect to an axis of the rotating shafts; one end of each of the rotating shafts close to a corresponding rotating groove is of a curved surface structure; the curved surface structure of each of the rotating shafts is tangent to the plurality of supporting surface structures of the corresponding rotating groove for realizing rotation of the rotating base.

2. The lens prism module according to claim 1, wherein the plurality of supporting surface structures of each of the rotating grooves are rotationally symmetrical with respect to the axis of the rotating shafts.

3. The lens prism module according to claim 1, wherein the plurality of supporting surface structures of each of the rotating grooves comprise a first supporting surface structure, a second supporting surface structure, and a third supporting surface structure; included angles between the first supporting surface structure, the second supporting surface structure, and the third supporting surface structure of each of the rotating grooves are equal.

4. The lens prism module according to claim 1, wherein the driving assembly comprises a first driving coil disposed on the fixed base and a first driving magnet disposed on the rotating base; the first driving coil is disposed opposite to the first driving magnet.

5. The lens prism module according to claim 1, wherein the lens prism module further comprises return magnet groups oppositely disposed on the fixed base and the rotating base; the return magnet groups comprise a first return magnet group disposed on the rotating base and a second return magnet group disposed on the fixed base.

6. The lens prism module according to claim 5, wherein the first return magnet group comprises four first return magnets oppositely disposed on two sides of the rotating base; each two of the four first return magnets are separately disposed on two sides of a corresponding rotating groove; each two of the four first return magnets disposed on the corresponding rotating groove distributed in a straight line with the corresponding rotating groove; the second return magnet group comprises four second return magnets oppositely disposed on two sides of the fixed base; each of the second return magnets is disposed directly opposite to a corresponding first return magnet.

7. The lens prism module according to claim 1, wherein an avoiding groove for avoiding one end of the prism is provided on a bottom surface of the fixed base.

8. The lens prism module according to claim 1, wherein the lens prism module further comprises a Hall sensor disposed on the fixed base and a Hall magnet disposed on the rotating base; the Hall magnet is disposed opposite to the Hall sensor.

9. The lens prism module according to claim 1, wherein the lens prism module further comprises a circuit board disposed under the fixed base; the circuit board is connected with the fixed base through a reinforcing plate.
